(19) United States
(12) Patent Application Publication
(10) Pub. No.: US 2008/0073930 A1
(43) Pub. Date: Mar. 27, 2008

(54) MOTORCYCLE WINDSHIELD

(76) Inventor: Jerry A. Edwards, Portland, OR (US)

Correspondence Address: IAN F. BURNS & ASSOCIATES, P.O. BOX 71115, RENO, NV, 89570, US

(21) Appl. No.: 11/759,178

(22) Filed: Jun. 6, 2007

Related U.S. Application Data
(60) Provisional application No. 60/807,113, filed on Jul. 12, 2006.

(51) Int. Cl. B62J 17/04

(52) U.S. Cl. 296/78.1

(57) ABSTRACT

A windshield for use with a motorcycle. The windshield includes a panel formed from a transparent material. The panel has front and rear sides, top and bottom sides and a pair of sides. A mounting mechanism attaches the panel to a motorcycle. A curved outer peripheral edge is attached to the panel and extends outwardly from the panel. The curved outer peripheral edge further has a portion that extends toward the front side. The curved outer peripheral edge directs airflow away from a motorcycle rider.

### FIELD OF THE INVENTION

The present invention relates to motorcycles, and more particularly to a windshield for use with a motorcycle.

### BACKGROUND

Windshields are used on motorcycles to block the wind for the comfort of the rider. Various types of windshields are known in the art. Some windshields are large and deflect almost all of the airflow away from the rider. Large windshields tend to look rather poorly and out of proportion to the motorcycle they are attached to. Small windshields are more aesthetically pleasing. However, small windshields do not direct all of the airflow away from the rider and the rider using a small windshield may experience significant airflow. What is needed is a smaller windshield that can provide the airflow protection afforded by larger windshields.

### SUMMARY OF ONE EMBODIMENT OF THE INVENTION

### Advantages of One or More Embodiments of the Present Invention

The various embodiments of the present invention may, but do not necessarily, achieve one or more of the following advantages:

provide a motorcycle windshield that can protect a rider from dirt, rocks, and bugs;

provide a motorcycle windshield that can improve rider comfort by blocking airflow on the rider;

provide a motorcycle windshield that can improve rider comfort by deflecting airflow around a rider;

provide a motorcycle windshield that is aesthetically pleasing;

provide a motorcycle windshield that has a small overall size and can block airflow the same as a larger windshield; and

provide a motorcycle windshield that has a curved outer peripheral edge.

These and other advantages may be realized by reference to the remaining portions of the specification, claims, and abstract.

### Brief Description of One Embodiment of the Present Invention

In certain embodiments, the present invention relates to a windshield for use with a motorcycle. The windshield includes a panel formed from a transparent material. The panel has front and rear sides, top and bottom sides and a pair of sides. A mounting mechanism attaches the panel to a motorcycle. A curved outer peripheral edge is attached to the panel and extends outwardly tram the panel. The curved outer peripheral edge further has a portion that extends toward the front side. The curved outer peripheral edge directs airflow away from a motorcycle rider.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description, or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a side perspective view of a motorcycle with a windshield of the present invention.

FIG. 2 is substantially an isometric view of windshield of the present invention.

FIG. 3 is substantially a front view of FIG. 2.

FIG. 4 is substantially a cross-sectional view taken along section lines A-A of FIG. 2.

FIG. 5 is substantially an enlarged view of a portion of FIG. 2 showing a curved outer peripheral edge.

FIG. 6 is substantially an enlarged view of a portion of FIG. 2 showing another curved outer peripheral edge.

FIG. 7 is substantially an enlarged view of a portion of FIG. 2 showing an additional curved outer peripheral edge.

FIG. 8 is substantially an enlarged view of a windshield edge showing airflow around a windshield edge of the prior art.

FIG. 9 is substantially an enlarged view of a portion of FIG. 2 showing airflow around the curved outer peripheral edge.

FIG. 10 is substantially an alternative embodiment of a curved outer peripheral edge of the present invention.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

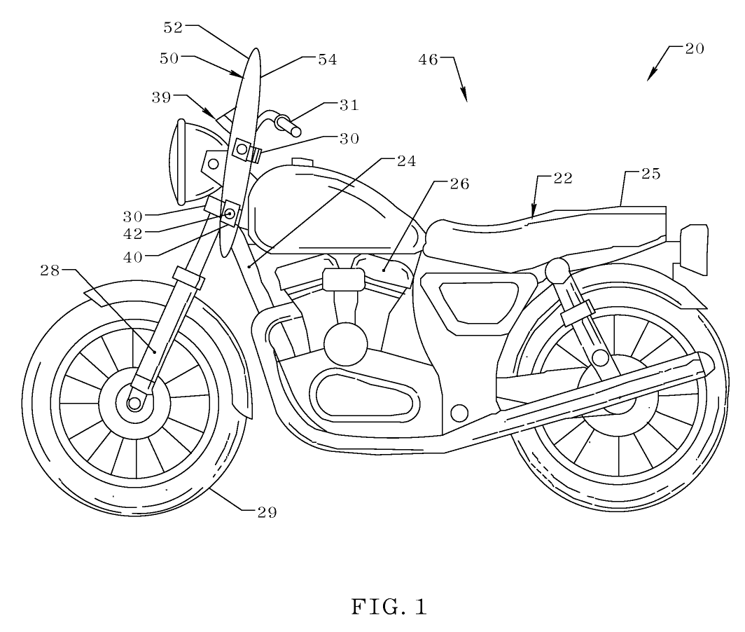

Referring to FIG. 1, a motorcycle and windshield assembly 20 is shown. A conventional motorcycle 22 can have a frame 24. Frame 24 supports a seat 25 and engine 26. A steering crown or triple tree 30 is mounted to frame 24. Steering crown 30 can rotate with respect to frame 24. A fork 28 is mounted to the steering crown 30. Steering crown 30 allows the front wheel 29 to turn when the handlebar 31 is moved. A mounting mechanism 39 connects windshield 50 to motorcycle 22.

Mounting mechanism 39 can include a bracket 40 that is attached to steering crown 30 on one end and that is attached to windshield 50 at another end. A fastener 42 can be used to attach windshield 50 to bracket 40. Fastener 42 can be any suitable fastener such as a bolt, rivet or screw. A rider (not shown) would be seated on seat 25 and located in a shielded area or protected region 46 that is protected from wind when motorcycle 22 is moving. When motorcycle 22 is moving, airflow is directed or deflected by windshield 50 around the rider such that the rider experiences reduced airflow. Windshield 50 can also protect a rider from rocks, bugs and other road debris.

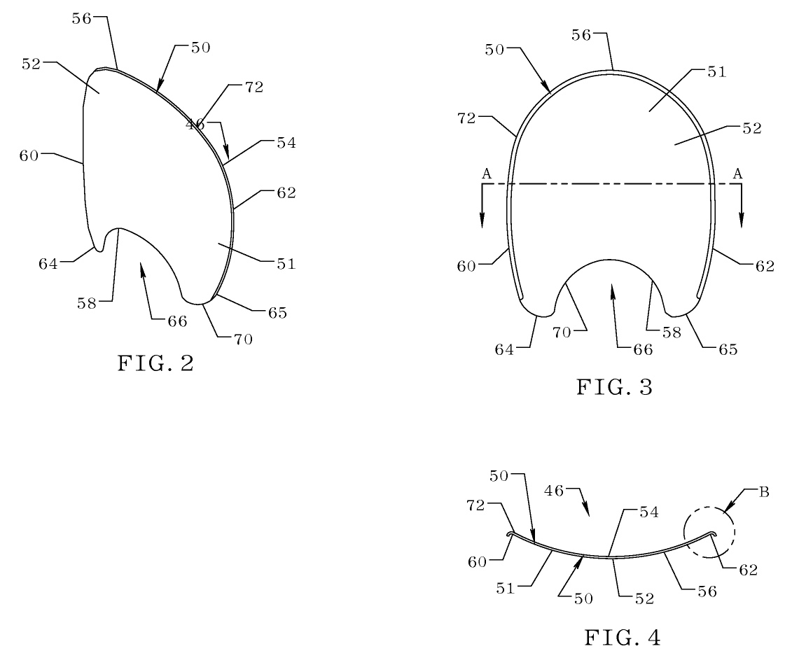

Turning to FIGS. 2-4, additional details of windshield 50 will now be described. Windshield 50 can include a panel 51 that may be formed from a transparent material such as plexiglass, acrylic, tempered glass or other suitable materials. Panel 51 may be molded, extruded, cast or heat formed. Panel 51 can have a concave shape as seen in FIG. 4. Panel 51 may have a front side 52, rear side 54, top side 56, bottom side 58 and sides 60 and 62. A pair of lower sections or areas 64 and 65 can extend below bottom side 58. A recess 66 is defined between lower sections 64 and 65. Lower sections 64 and 65 nay have a non-curved outer edge 70 that extends from lower sections 64 and 65. Panel 51 may further have a curved outer peripheral edge 72 that extends from top side 56, bottom side 58 and sides 60 and 62 in an outwardly manner from panel 51. Curved outer peripheral edge 72 may be formed integrally with panel 51 or may be attached as a separate piece to panel 51.

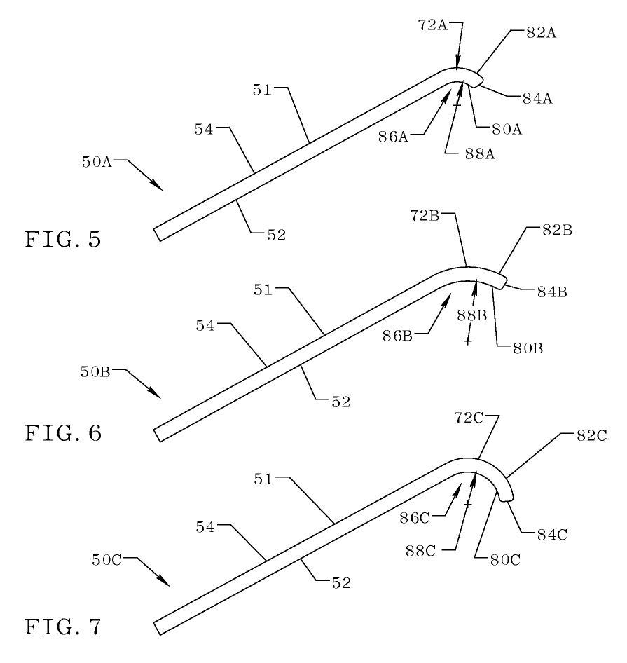

With reference now to FIG. 5, an enlarged view of a windshield 50A and outer peripheral edge 72A are shown. Outer peripheral edge 72A can further include an outer curve surface 80A, an inner curve surface 82A and an edge end 84A. A cavity 86A is defined inwardly from inner curved surface 82A. Inner curved surface 82A may have a radius 88A.

As seen in FIG. 6, another windshield 50B is shown. Windshield 50B is similar to windshield 50A, except that outer peripheral edge 72B is different. The length of outer curve surface 80B and inner curve surface 82B are longer allowing more of a curve. Windshield 50B has an edge end 84B and radius 88B.

FIG. 7 illustrates an additional windshield 50C. Windshield 50C is similar to windshield 50B, except that outer peripheral edge 72C is different. The length of outer curve surface 80C and inner curve surface 82C are longer allowing an even greater curve. Windshield 50C has an edge end 84C and radius 88C.

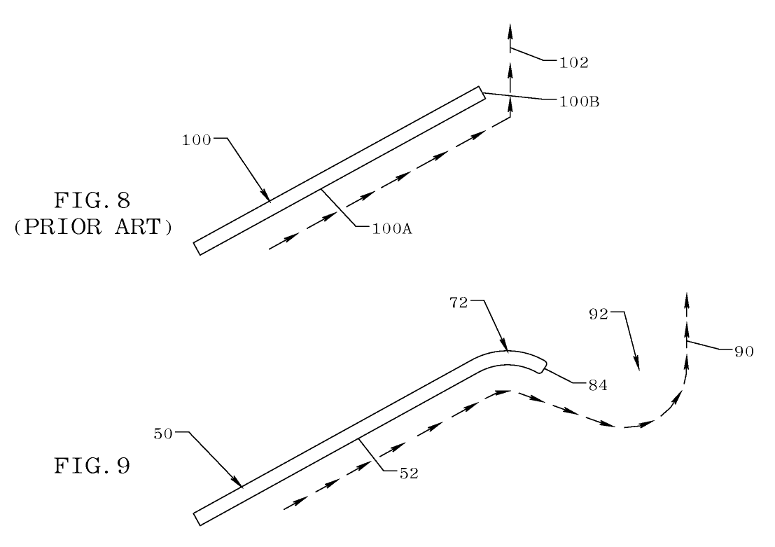

Turning now to FIG. 8, airflow around the windshield edge of a prior art windshield 100 is shown. Windshield 100 has a straight edge. Airflow 102 follows along the front surface 100A of windshield 100 and then flows around and next to the end 100B.

With reference to FIG. 9, airflow around the curved outer peripheral edge 72 of windshield 50 in accordance with the present invention is shown. Windshield 50 has curved outer peripheral edge 72. Airflow 90 follows along the front side 52 of windshield 50 and then is directed by curved outer peripheral edge 72 to flow outwardly away from end 84. Curved outer peripheral edge 72 causes airflow 90 flowing over curved outer peripheral edge 72 to create a low or no airflow area 92 extending outwardly from end 84. Airflow 90 is forced by curved outer peripheral edge 72 to flow first away from front side 52 and then outwardly away from end 84 defining low or no airflow area 92.

Because curved outer peripheral edge 72 creates no airflow area 92, windshield 50 can be made smaller while still providing the same amount of airflow protection afforded by a larger windshield. The smaller windshield can have a cleaner, streamlined appearance while still offering excellent airflow deflection around a rider.

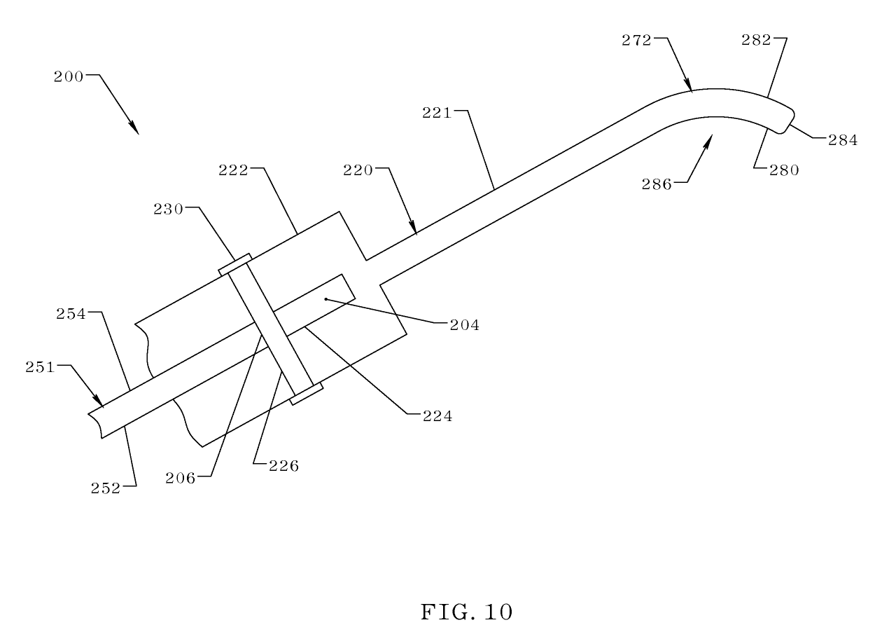

With reference now to FIG. 10, an enlarged view of another windshield 200 is shown. Windshield 200 can include a planar panel 251 with a straight outer edge and a curve attachment 220 that is mounted or attached to planar panel 251.

Windshield 200 can include a planar panel 251 that may be formed from a transparent material such as plexiglass, acrylic, tempered glass or other suitable materials. Panel 251 may be molded, extruded, cast or heat formed. Panel 251 can have a concave shape. Panel 251 may have a front side 252, rear side 254 and a straight end 204. A hole 206 extends through panel 251 between sides 252 and 254.

A curve attachment 220 can have a base 222 and a curved outer peripheral edge 221 extending from the base. Curve attachment 220 may be formed from a transparent material such as plexiglass, acrylic, tempered glass or other suitable materials. Channel 224 is located in base 222 and has a hole 226 extending there through. A fastener 230 may be used to attach curve attachment 220 to panel 251. Fastener 230 can extend through holes 206 and 226. Fastener 230 can be any suitable fastener such as a rivet bolt or screw. Curve attachment 220 could also be attached to panel 251 by the use of an adhesive.

Curved outer peripheral edge 221 can further include an outer curve surface 282, an inner curve surface 280 and an edge end 284. A cavity 286 is defined inwardly from inner curved surface 280.

Windshield 200 can function in the same manner as previously described for windshield 50 in deflecting airflow away from a motorcycle rider. Curve attachment 220 can be used with existing windshields to add a curved outer peripheral edge without having to replace the entire windshield.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A windshield comprising:
(A) a panel formed from a substantially transparent material, the panel having a front and rear side and a top, a bottom and first and second sides;
(B) a mounting mechanism coupled to the panel for allowing the panel to be mounted to a motorcycle; and
(C) a curved outer peripheral edge attached to at least the top, the first and the second sides and extending outwardly from the top, the first and the second sides, the curved outer peripheral edge further having a portion that at least partially extends toward the front side, the curved outer peripheral edge configured to direct airflow away from the panel.

2. The windshield of claim 1, wherein the panel has a concave shape.

3. The windshield of claim 1, wherein the panel has a pair of sections that extend downwardly from the bottom side.

4. The windshield of claim 3, wherein the sections define a recess.

5. The windshield of claim 1, wherein the curved outer peripheral edge has a radius.

6. The windshield of claim 1, wherein the curved outer peripheral edge has an outer curve surface, an inner curve surface and an edge end.

7. A windshield comprising:
(A) a panel formed from a substantially transparent material, the panel having a front side, a rear side and a top, a bottom and first and second sides;
(B) a curved outer peripheral edge attached to at least one of the sides and extending outwardly from the side, the curved outer peripheral edge configured to deflect airflow, the curved outer peripheral edge having a base with a channel extending into the base, at least a portion of the panel being received and retained in the channel.

8. The windshield of claim 7, wherein at least one fastener retains the curved outer peripheral edge to the panel.

9. The windshield of claim 7, wherein the curved outer peripheral edge is formed from a transparent material.

10. The windshield of claim 7, wherein the curved outer peripheral edge has an outer curve surface, an inner curve surface and an edge end.

11. The windshield of claim 7, wherein a mounting mechanism is coupled to the panel for allowing the panel to be mounted to a motorcycle.

12. The windshield of claim 8, wherein at least one hole extends through the panel and the base, the fastener extending through the hole.

13. A windshield comprising:
(A) panel means for providing a transparent wind screen, the panel means having a front side, a rear side and a top, a bottom and first and second sides;
(B) mounting means for allowing the panel means to be mounted to a motorcycle, the mounting means being coupled to the panel means, and
(C) curved outer peripheral edge means for deflecting airflow away from a rider, the curved outer peripheral edge means attached to at least the top, the first and the second sides and extending outwardly from the top, the first and the second sides, the curved outer peripheral edge means further having a portion that at least partially extends toward the front surface.

14. The windshield of claim 13, wherein the panel means has a concave shape.

15. The windshield of claim 13, wherein the panel means has a pair of sections that extend downwardly from the bottom side.

16. The windshield of claim 15, wherein the sections define a recess.

17. The windshield of claim 13 wherein the curved outer peripheral edge means has a radius.

18. The windshield of claim 13, wherein the curved outer peripheral edge means further comprises an outer curve surface, an inner curve surface and an edge end.

19. The windshield of claim 13, wherein the curved outer peripheral edge means further comprises a base having a channel.
